(19) United States
(12) Patent Application Publication
(10) Pub. No.: US 2025/0365249 A1
(43) Pub. Date: Nov. 27, 2025

(54) DEVICE AND APPLICATION CONTEXT AWARE PRIORITIZATION CONFIGURATION IN INTERNET PROTOCOL HEADERS OF EDGE ENVIRONMENTS

(71) Applicant: Dell Products L.P., Round Rock, TX (US)

(72) Inventors: Parminder Singh Sethi, Ludhiana (IN); Lakshmi Saroja Nalam, Bangalore (IN); Praveen Kumar, Noida (IN)

(21) Appl. No.: 18/670,848

(22) Filed: May 22, 2024

(51) Int. Cl. H04L 47/6275; H04L 47/24; H04L 69/22

(52) U.S. Cl. CPC H04L 47/6275; H04L 47/24; H04L 69/22

(57) ABSTRACT

A method for prioritizing network packets in an edge environment includes: monitoring, by an edge environment engine, the edge environment to obtain environment telemetry data from edge devices in the edge environment, analyzing, by an analyzing agent of the edge environment engine, the environment telemetry data, to obtain environment topology information, generating, using a prioritized rank model and using the environment topology information, a prioritization policy that includes a mapping between an application and a prioritization rank, and sending, by the edge environment engine, the prioritization policy to each of the edge devices in the edge environment, wherein the edge devices apply the prioritization policy to prioritize the network packets when transmitting the network packets to other devices.

### BACKGROUND

In an edge environment, edge devices frequently transmit network packets to other devices. A Differentiated Services (DiffServ) policy specifies a classification for network packets being transmitted from applications, but does not include a method for prioritizing network packets based on device health or the category of the application. Currently, there is no context-aware packet classification method for network packets being transmitted on an edge environment.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system including an edge environment with an edge environment engine in accordance with one or more embodiments of the invention.

FIG. 1.2 shows a diagram of an edge device in accordance with one or more embodiments of the invention.

FIG. 1.3 shows a diagram of an edge environment engine in accordance with one or more embodiments of the invention.

FIG. 2.1 shows a flowchart of a method for generating a prioritization policy in accordance with one or more embodiments of the invention.

FIG. 2.2 shows a flowchart of a method for implementing a prioritization policy on a network packet in accordance with one or more embodiments of the invention.

FIG. 3 shows a diagram of an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments of the invention relate to system and methods for prioritizing the transmission of network packets in an edge environment. More specifically, the prioritization of the network packets may be done by applying a specific prioritization rank value to the Internet Protocol (IP) header of each of the network packets in an edge environment. The prioritization ranks that are assigned to the network packets are associated with the application from which the network packets originate. Each of the ranks are determined by a generated prioritization policy, which is generated using a prioritized rank model and is based on the telemetry and topology information of all the edge devices in the edge environment as well as a Differentiated Services (DiffServ) policy.

One or more embodiments of the invention improves upon the traditional method of prioritizing network traffic. In current implementations, there is no context aware packet classification or ranking. Current implementations of prioritization may include using the DiffServ policy when managing the transmission of packets. DiffServ policies may provide a classification for a standardized set of classes of traffic on a per-application basis, and may not incorporate any data or information on the telemetry or topology information of any edge devices on the edge environment which is transmitting the network packets. The system and method described below elaborate on the inclusion of an environmentally-aware prioritization rank in the transmission of network packets.

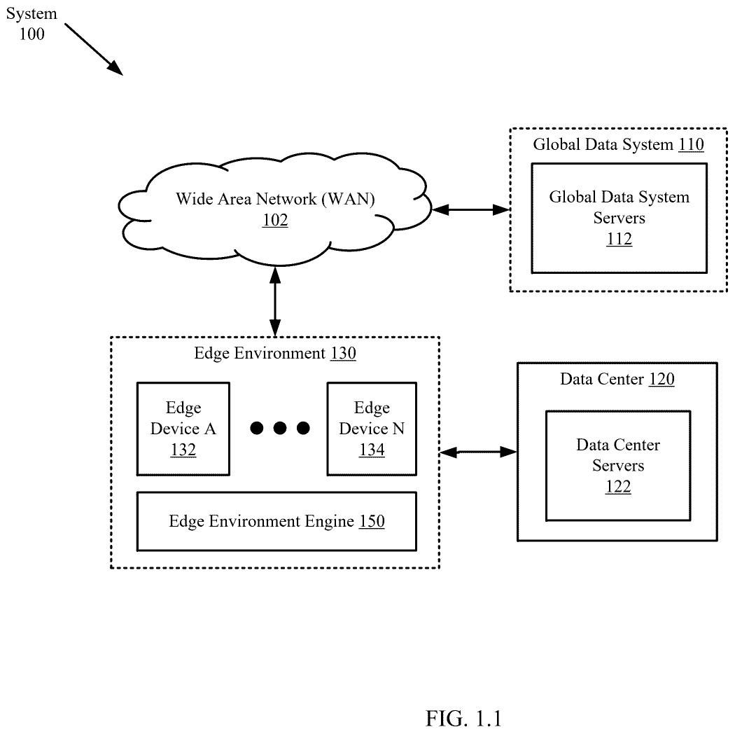

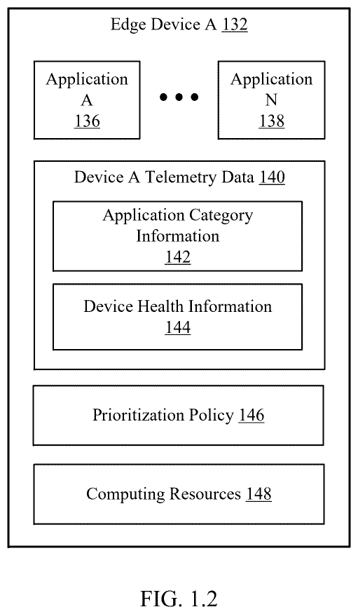

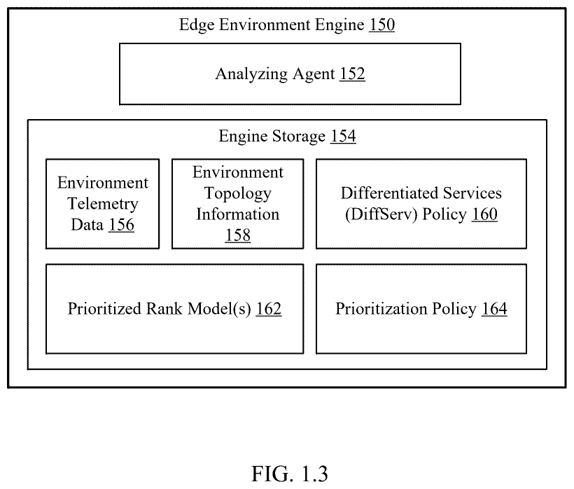

FIG. 1.1 shows a diagram of a system in accordance with one or more embodiments of the invention. The system may include a wide area network (WAN) (102), a global data system (110), a data center (120), and an edge environment (130). The system may include additional, fewer, and/or other components without departing from the invention. Each of the components in the system may be operatively connected via any combination of wireless and/or wired networks, e.g., the WAN (102).

In one or more embodiments, the WAN (102) is the wide area network that performs the functionality of allowing communication between components of the system described throughout this application. The WAN (102) may include any number of devices within any components of the system, as well as devices external to or between such components of the system. The WAN (102) provides the operative connectivity between the global data system (110) and the edge network (130). Each of the aforementioned system components connected by the WAN (102) will be described in detail below.

In one or more embodiments, the global data system (110) may include a plurality of global data system servers (112) without departing from the invention. The global data system servers (112) may provide computer-implemented services to users operating at least one of the edge devices (132, 134) and/or the data center (120). The global data system (110) may operate in a cloud environment, accessible by the edge environment (130), and/or any other entity via the wide area network (102). In one or more embodiments, the computer-implemented services provided by the global data system servers (112) include data storage, data processing, data collection (e.g., using the edge environment (130)), and application execution. Other computer-implemented services may be offered by the global data system (110) without departing from the invention.

In one or more embodiments, the data center (120) may include a plurality of data center servers (122) without departing from the invention. The data center (120), similar to the global data system (110), may provide computer-implemented services to users. In contrast to the global data system (110), the data center (120) may include direct connections to the edge environment (130). For example, the data center servers (122) of the data center (120) may be located locally to the users operating the data center (120).

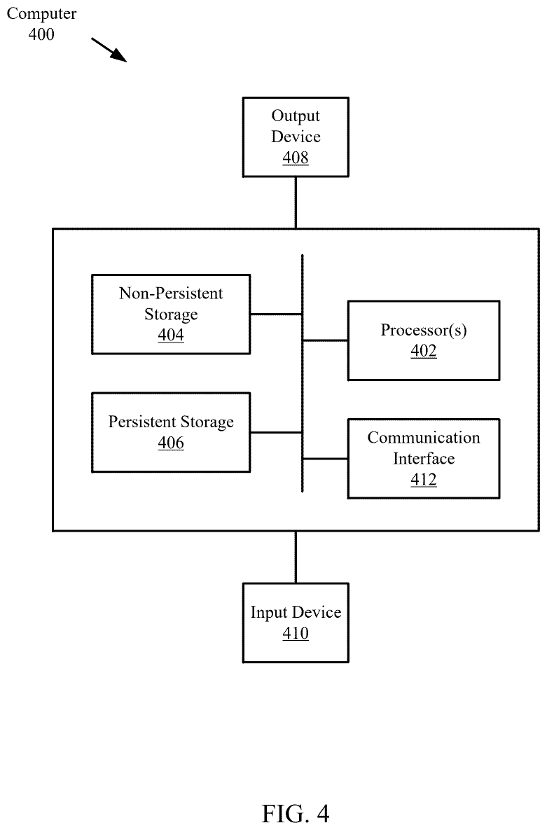

In one or more embodiments, each of the data center servers (122) is implemented as a computing device (see e.g., FIG. 4). The computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, it will cause the computing device to perform the functionality of the data center servers (122) as described throughout this application.

In one or more embodiments, the edge environment (130) may be a data architecture that may include a plurality of edge devices (132, 134) across any number of edge networks (not shown) of the edge environment. An edge environment (130) may be implemented on a system with the intention of transmitting network packets to other devices either inside or outside of the edge environment (130). A plurality of edge devices (132, 134) may exist on the edge environment (130), along with an edge environment engine (150). Examples of an edge device may include, but are not limited to, a smartphone, a laptop, a tablet, a sensor, a router, a WAN access device, etc. An edge device is not limited to the aforementioned examples and may be another type of device without departing from the scope of the invention. Additional details for the functionality of an individual edge device (132, 134) may be found, for example, in FIG. 1.2.

In one or more embodiments, each edge device (132, 134) is implemented as a computing device (see e.g., FIG. 4). The computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, it will cause the computing device to perform the functionality of the edge devices (132, 134) as described throughout this application.

In one or more embodiments, each edge device (132, 134) may transmit any number of network packets to any other devices or servers in the system. Devices that receive network packets from an edge device may include, but are not limited to, another edge device (132, 134), any data system server (122), or any global data system server (112). In the context of this invention, a network packet refers to a unit of data that is being transmitted from an application on an edge device (132, 134). Additional information on the applications (136, 138, FIG. 1.2) found in an edge device (132, FIG. 1.2) can be found, for example, in FIG. 1.2. Each network packet may include, but is not limited to, a header and a payload.

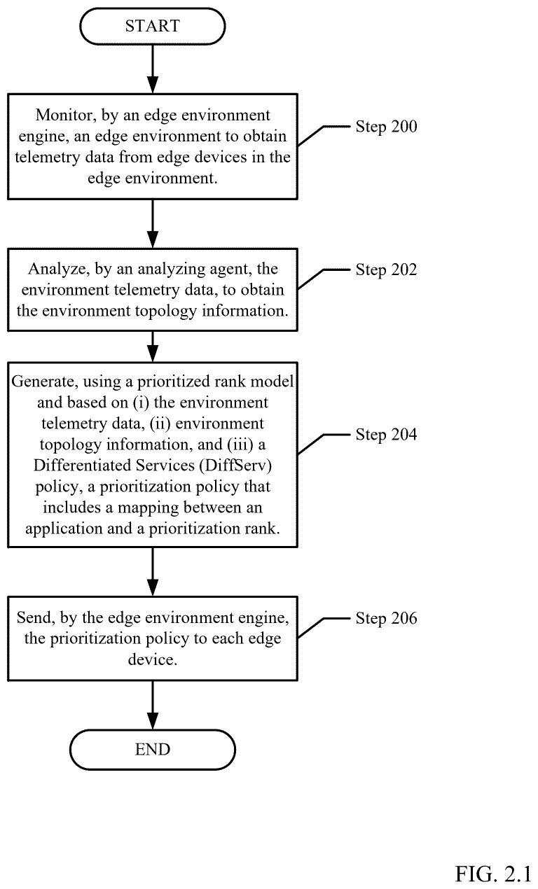

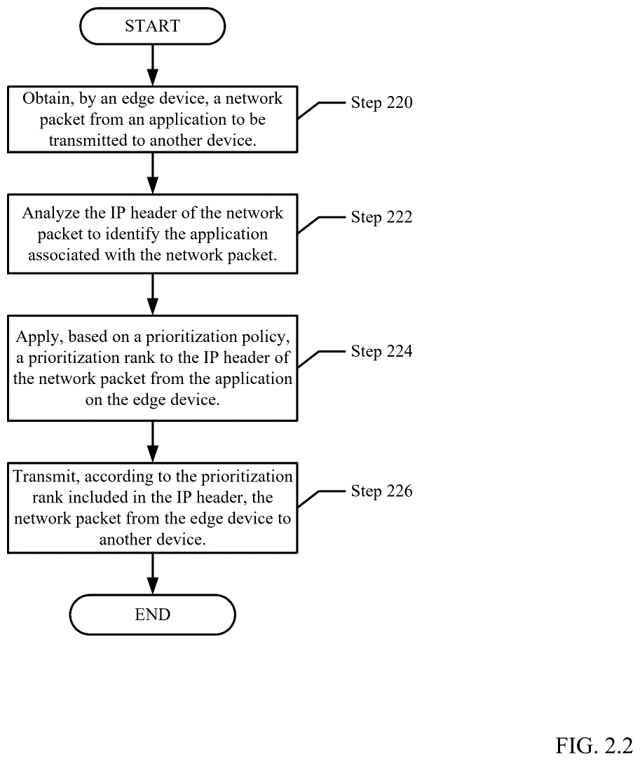

Based on the protocol implemented for the network packet transmission, the header may specify information used for the routing, forwarding, or modification of the network packets for proper data transmission between devices. For example, if the data transmission is implemented using the Internet Protocol (IP), the header of a network packet may be referred to as an IP header. The IP header of a network packet may include information such as the IP address of the edge device (132, 134) that sent the packet, the IP address of the device that receives the packet, and any other relevant identifying information. In the context of this invention, in a DiffServ environment, the IP header may include a 6-bit DiffServ code point (DSCP) in an 8-bit DiffServ field in order to classify the packet. The payload of the network packet may include any form of transmittable data from the applications (136, 138, FIG. 1.2) of the edge device (132, FIG. 1.2). Additional information on the prioritization of network packets, including a prioritization ranking applied to the IP header, can be found, for example, in FIGS. 2.1-2.2.

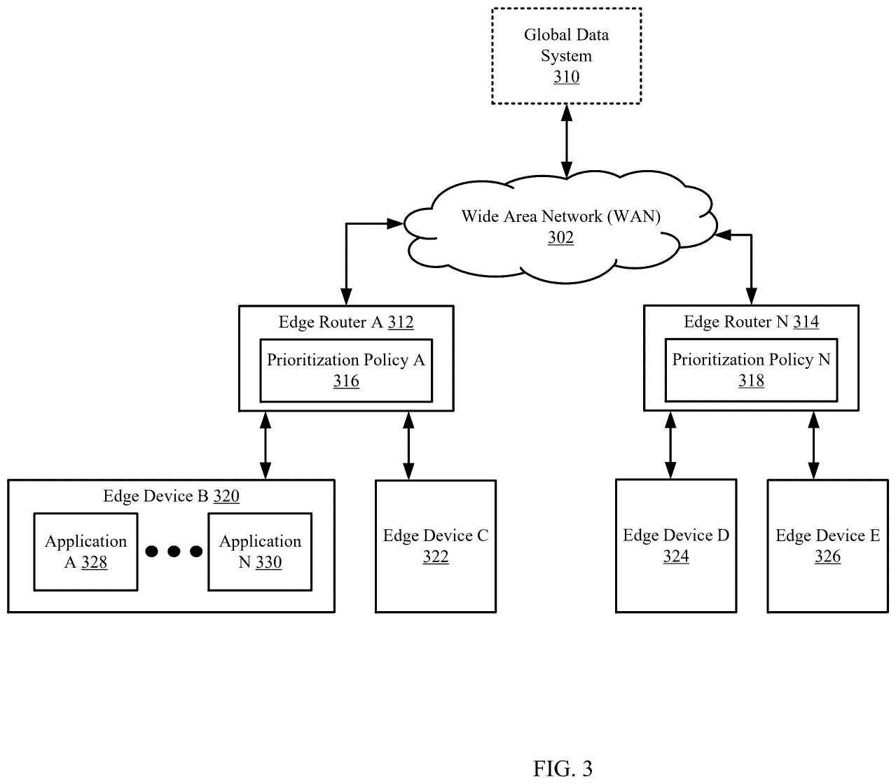

In one or more embodiments, the edge environment engine (150) refers to an engine that analyzes the devices in the edge environment (150) in order to generate a prioritization policy (164, FIG. 1.3) to prioritize network packets being transmitted by edge devices (132, 134). In one or more embodiments, the edge environment engine (150) may be implemented as an edge router (312, 314, FIG. 3) between the WAN (102) and any number of edge devices (132, 134) on the edge environment (130). Additional details for the components and functionality of the edge environment engine (150) may be found, for example, in FIGS. 1.3, 2.1, and 3.

Turning now to FIG. 1.2, FIG. 1.2 shows a diagram of an individual edge device (132) in accordance with one or more embodiments of the invention. The edge device (132) of FIG. 1.2 may be an embodiment of an edge device (132, 134, FIG. 1.1) discussed above. The edge device may include a plurality of applications (136, 138), device telemetry data (140), and other computing resources (146). The edge device (132) may include additional, fewer, and/or different components without departing from the invention. Each of the aforementioned components of the edge device (132) is discussed below.

In one or more embodiments, the applications (136, 138) refer to at least one application that may exist on the edge device (132) and may perform a variety of functionalities for the edge device. Functionalities of the applications may include a plurality of different tasks, including but not limited to any number of software, data managers, media players, data collection (e.g., from sensors of the edge device (132)) etc. The applications (136, 138) may generate any number of network packets to be transmitted to other devices in the system. Information on the classification of the applications in the edge environment (130, FIG. 1.1) may be found, for example, in the Differentiated Services (DiffServ) Policy (160, FIG. 1.3).

In one or more embodiments, device telemetry data (140) refers to the storage system within each edge device on an edge environment (130, FIG. 1.1). The type of storage(s) on each edge device is dependent on the type of edge device discussed previously (132, 134, FIG. 1.1). Device telemetry data (140) may include application category information (142) and device health information (144). The device telemetry data (140) may include additional, fewer, and/or different components without departing from the invention. Each of the aforementioned components of the device telemetry data (140) is discussed below.

In one or more embodiments, the application category information (142) in the device telemetry data (140) may refer to data that shows the category of an application (136, 138) on an edge device (132). An application category may refer to a group of applications (e.g., 136, 138) that have similar capabilities or implementations in the system (100, FIG. 1.1). Categories of applications may include, but are not limited to, data managers, media players, data collectors (e.g. from sensors of the edge device (132)) etc. The device health information (144) in the device telemetry data (140) may include information about the operation (e.g., workload, available computing resources (148), etc.) of the edge device (132) during a period of time. The device health information (144) of the edge device (132) may also include a device degradation rate, which refers to how quickly the computing resources (148) of the edge device (132) are expected to be depleted based on the current utilization. Additional information on the utilization of the application category information (142) and device health information (144) of the device telemetry data (140) can be found, for example, in FIG. 1.2.

In one or more embodiments, the prioritization policy (146) refers to a policy generated by the edge environment engine (150, FIG. 1.1, FIG. 1.3) that defines the prioritization rank of network packets in the edge environment (130, FIG. 1.1). The prioritization policy (146) on each edge device (132) may be the same or different prioritization policy (164, FIG. 1.3) that is stored in the engine storage (154, FIG. 1.3) of the edge environment engine (150, FIG. 1.1, FIG. 1.3) discussed at length below. Additional detail on the prioritization policy (146) can be found, for example, in the discussion of the edge environment engine (150, FIG. 1.1, FIG. 1.3). The prioritization policy (146) may be generated and stored in the edge device (132) in accordance with the methods of FIG. 2.1 and FIG. 2.2.

In one or more embodiments, computing resources (148) may refer to hardware or software elements of the edge device (132) that may be available or unavailable to perform tasks and/or used to execute the applications (136, 138). Computing resources (148) may include, but are not limited to, resources such as volatile storage, persistent storage, CPU usage, GPU usage, power, and networking interfaces. The computing resources (148) available to each edge device (132) may be dependent on the workload on the device at any given time, discussed at length below in FIG. 2.2, and the type of edge device (132, 134, FIG. 1.1), discussed previously in FIG. 1.1.

Turning now to FIG. 1.3, FIG. 1.3 shows a diagram of an edge environment engine (150) in accordance with one or more embodiments of the invention. The edge environment engine (150) of FIG. 1.3 may be an embodiment of an edge environment engine (150, FIG. 1.1) discussed above. The edge environment engine may include an analyzing agent (152) and an engine storage (154). The edge environment engine (150) may include additional, fewer, and/or different components without departing from the invention. Each of the aforementioned components of the edge environment engine (150) is discussed below.

In one or more embodiments, the analyzing agent (152) refers to an agent on the edge environment engine (150) that includes functionality for analyzing environment telemetry data (156) for all of the edge devices (132, 134, FIG. 1.1) on the edge environment (130, FIG. 1.1) in order to generate the environment topology information (158) described below. The analyzing agent (152) analyzes the data of one or more edge devices (132, 134, FIG. 1.1) in order to have a fully context-aware understanding of the edge devices, the application category information (142, FIG. 1,2) of the applications (136, 138, FIG. 1.2) on each edge device, and the device health information (144, FIG. 1.2) of each edge device. Additional information on the implementation of the analyzing agent (152) in the methodology of the embodiments of this invention can be found, for example, in FIG. 2.1.

In one or more embodiments, the engine storage (154) may include environment telemetry data (156), environment topology information (158), a Differentiated Services (DiffServ) policy (160), prioritized rank model(s) (162), and a prioritization policy (164). The engine storage (154) may include additional, fewer, and/or different components without departing from the invention. Each of the aforementioned components of the engine storage (154) is discussed below.

In one or more embodiments, the environment telemetry data (156) refers to the telemetry data (140, FIG. 1.2) of each edge device (132, FIG. 1.2) of the edge devices (132, 134, FIG. 1.1) of the system shown in FIG. 1.1. Details on the content of the telemetry data (140, FIG. 1.2) of each of the edge devices can be found, for example, in FIG. 1.2. The edge environment engine (150) continuously monitors the edge devices in order to obtain this environment telemetry data (156). Additional information on the acquisition and implementation of the environment telemetry data can be found, for example, in FIG. 2.1.

In one or more embodiments, the environment topology information (158) refers to information about the organization and structure of the system of FIG. 1.1. The environment topology information (158) may be obtained from the analysis of the environment telemetry data (140, FIG. 2.1) by the analyzing agent (152) discussed above. In the context of this invention, environment topology information (158) refers to how the edge devices (132, 134, FIG. 1.1) are organized and utilized on the edge environment (130, FIG. 1.1). Environment topology information (158) may include content such as the layout of the device network, which edge devices (132, 134) are awake or asleep, the workload for the devices, the device degradation rate of the devices, computer resource usage, the direct connections of each of the edge devices (132, 134) to other edge devices (132, 134) or other devices, etc. The environment topology information (158) of a system may include other information about the system without departing from the context of this invention.

In one or more embodiments, the DiffServ policy (160) refers to a policy in the engine storage (154) that includes information on the classification of network packets based on the category of application (136, 138, FIG. 1.2) that the network packet originates from. In this implementation, each edge device (132, 134, FIG. 1.1) in the edge environment (130, FIG. 1.1) shares the same DiffServ policy (160). The classification for applications (136, 138, FIG. 1.2) included in the DiffServ policy may be included in the IP header of a network packet that is being transmitted by an application (136, 138, FIG. 1.2). The DiffServ policy (160) may include information such as, but not limited to, the number of hops needed to transmit data or network packets in between two devices in the system (100, FIG. 1.1), the amount of downtime required for a transmission of a network packet, the required disaster recovery measures associated with the application, and the required response time for the application. For example, the prioritization policy (164), once generated based on the DiffServ policy (160), may require that first class applications be marked with a higher priority ranking, therefore prioritizing the transmission of the network packets of a higher class. Additional information on the implementation of the DiffServ policy (160) may be found, for example, in FIG. 2.1.

In one or more embodiments, the prioritized rank model(s) (162) may refer to one or more trained models that may use, for example, multiple linear regression to generate the prioritization policy (164) based on the environment telemetry data (156) of all edge devices (132, 134, FIG. 1.1) in the edge environment (130, FIG. 1.1), the environment topology information (158) of all edge devices (132, 134, FIG. 1.1) in the edge environment (130, FIG. 1.1) generated by the analyzing agent (152), as well as the DiffServ policy (160). Additional information on the implementation of the prioritized rank model(s) (162) may be found, for example, in FIG. 2.1.

In one or more embodiments, the prioritization policy (164) refers to the policy generated by the prioritized rank model(s) (162) based on the environment telemetry data (156) of all edge devices (132, 134, FIG. 1.1) in the edge environment (130, FIG. 1.1), the environment topology information (158) of all edge devices (132, 134, FIG. 1.1) in the edge environment (130, FIG. 1.1) generated by the analyzing agent (152), as well as the DiffServ policy (160) discussed previously. The prioritization policy (164) takes into account the health of each device, the category of the applications on each devices The prioritization policy (164) is shared with and enforced by the edge devices (132, 134, FIG. 1.1) in order to prioritize network packets being transmitted by the applications (136, 138, FIG. 1.2) on the edge devices based on each corresponding application initiating the transmission of the network packets. The prioritization policy (1640 may specify a mapping between an application and a corresponding prioritization rank. For example, the prioritization policy (164) is applied to a network packet by identifying such corresponding application, determining a corresponding prioritizing rank based on the identified application, and including bits to represent the corresponding prioritization rank in the IP header of the network packet. Additional information on the generation and implementation of a prioritization policy (164) can be found, for example, in FIGS. 2.1, 2.2, and 3.

FIG. 2.1 shows a flowchart of a method for generating a prioritization policy in accordance with one or more embodiments of the invention. The method may be performed by, for example, the edge environment engine (150, FIG. 1.1, FIG. 1.3), including the environment telemetry data (156, FIG. 1.3), environment topology information (158, FIG. 1.3), a Differentiated Services (DiffServ) policy (164, FIG. 1.3), and the prioritized rank model(s) (162, FIG. 1.3). Other components of the system illustrated in FIGS. 1.1-1.3 may perform all, or a portion, of the method of FIG. 2.1 without departing from the invention.

While FIG. 2.1 is illustrated as a series of steps, any of the steps may be omitted, performed in a different order, include additional steps, and/or perform any or all of the steps in a parallel and/or partially overlapping manner without departing from the invention.

In Step 200, the edge environment is monitored by the edge environment engine to obtain telemetry data from each of the edge devices in the edge environment. Telemetry data from each of the edge devices in the edge environment may include information such as application category information for the applications on the edge devices and device health information. The edge environment engine stores the environment telemetry data in an engine storage.

In Step 202, environment topology information is obtained by the analyzing agent from analyzing the environment telemetry data. The analyzing agent analyzes the environment topology information and determines the location of each of the applications on the edge devices in the edge environment, as well as the category of the applications and the health of the edge device that they are on. The edge environment engine stores the environment topology information in the engine storage.

In Step 204, a prioritization policy is generated using a prioritized rank model. The prioritized rank model generates the prioritization policy based on the environment telemetry data obtained in Step 200, the environment topology information obtained in Step 202, and a DiffServ policy obtained from the engine storage of the edge environment engine. The DiffServ policy provides a classification for each of the applications on the edge devices in the edge environment. The prioritized rank model, in this methodology, may implement multiple linear regression in order to analyze the data and information discussed previously. The prioritization policy generated in this step includes a mapping between an application on an edge device in the edge environment and a prioritization rank. The prioritization rank may be a numeric identifier of a specified number of bits that can be applied to the IP header of a network packet being transmitted from an edge device.

In Step 206, the prioritization policy generated in Step 204 is sent to each edge device on the edge environment by the edge environment engine. Each edge device on the edge environment stores a version of the prioritization policy generated in Step 204 in order to apply the prioritization rank included in the policy to network packets that may be transmitted, as discussed, for example, in FIG. 2.2.

FIG. 2.2 shows a flowchart of a method for applying a prioritization policy to a network packet in accordance with one or more embodiments of the invention. The method may be performed by, for example, an edge device ((132, 134, FIG. 1.1), (132, FIG. 1.2)). Other components of the system illustrated in FIGS. 1.1-1.3 may perform all, or a portion, of the method of FIG. 2.2 without departing from the invention.

While FIG. 2.2 is illustrated as a series of steps, any of the steps may be omitted, performed in a different order, include additional steps, and/or perform any or all of the steps in a parallel and/or partially overlapping manner without departing from the invention.

In Step 220, a network packet from an application is obtained by an edge device to send to another device. The other device may be another edge device in the edge environment, a data center server in the data center, a global data system server in the global data system, or any other device accessible through the wide area network. The network packet includes at least an IP header and a payload of data associated with the application from the edge device.

In Step 222, the IP header of the network packet is analyzed in order to identify which application the network packet is associated with. The IP header includes, for example, information on the location of the edge device from which the network packet originates.

In Step 224, a prioritization rank is applied to the IP header of the network packet from the application on the edge device. The prioritization rank is based on the prioritization policy obtained by the edge device in Step 206 of FIG. 2.1. The prioritization rank is applied to the IP header by including the prioritized rank as bits in the IP header.

In Step 226, the network packet is transmitted from the edge device to another device according to the prioritization rank included in the IP header. Based on the prioritization ranks in the IP headers of the network packets being transferred, network packets with higher priority ranks will be transmitted accordingly. For example, for packets with a given prioritization rank, network packets tagged with higher prioritization ranks may be prioritized in a network device transmitting the network packet over other network packets not tagged with a prioritization rank or tagged with a lower prioritization rank.

To further describe the methodology in FIGS. 2.1 and 2.2, an Example section is provided below.

### EXAMPLE

The following section describes an example. The example, illustrated in FIG. 3, is not intended to limit the invention. Turning to the example, consider a scenario in which a system includes multiple edge routers prioritizing network packets from applications on multiple edge devices.

Turning to FIG. 3, FIG. 3 shows a diagram of an example system. For the sake of brevity, not all components of the example system are illustrated in FIG. 3. The example system includes at least a wide area network (WAN) (302), a global data system (310), multiple edge routers (312, 314), and multiple edge devices (320, 322, 324, 326). Each edge router (312, 314) contains a prioritization policy (316, 318). Each edge device contains multiple applications (328, 330). The edge routers (312, 314) may be an implementation of the edge devices (132, 134) seen in FIGS. 1.1 and 1.2. Other components in the system depicted in FIGS. 1.1-1.3 may perform all, or a portion of the method discussed in FIG. 3 without departing from the scope of the invention.

In the following example, the components of the example system illustrated in FIG. 3 are described below.

In this example, the edge routers (312, 314) communicate between the edge devices and the WAN. Each edge router has its own prioritization policy (316, 318), that is shared with each of the edge devices (320, 322, 324, 326) that are operatively connected to each router. For example, prioritization policy A (316) was generated on edge router A (312) based on the telemetry and topology information of edge devices B and C (320, 322) as well as a DiffServ policy that applies to all edge devices that may be connected to edge router A (312). All network packets that are transmitted from the applications (328, 330) on any of the edge devices (320, 322) that are connected to edge router A (312) have the same prioritization policy A (316) applied. In other words, any network packet that leaves any of the applications (328, 330) corresponding to edge router A (312) have a prioritization rank included in their IP header according to prioritization policy A (316). The network packets may be transmitted to any other devices in the system, including but not limited to, other edge devices connected to the same router (e.g. edge device C (322), edge router A (312)), edge devices (324, 326) connected to any other edge router (e.g. edge router N (314)), or any other device or server connect to the WAN (302), such as any number of devices or servers in the global data system (310).

For example, the health degradation rate of edge device B (320) may be rapidly increasing, meaning that the network packets from applications A (328) and N (330) may be at risk for not being transmitted before the health of edge device B (320) degrades completely. Since prioritization policy A (316) accounts for the device health information of each edge device (320, 322) connected to edge router A (312), a higher priority rank will be included in the IP headers of network packets being transmitted from applications (328, 330) on the rapidly degrading edge device B (320) so that the network packets are prioritized accordingly and are transmitted before transmitting network packets from a healthier device, e.g., edge device C (322).

Continuing on with this example, the application category of application A (328) on edge device B (320) may be of a higher class than the application category of application N (330). Since prioritization policy A (316) accounts for the application category information of each edge device (320, 322) connected to edge router A (312), a higher priority rank will be included in the IP headers of network packets being transmitted from application A (328). The network packets from the higher class application A (328) are prioritized accordingly and are transmitted before network packets from a lower class application, for example, application N (330).

### END OF EXAMPLE

As discussed above, embodiments of the invention may be implemented using computing devices. Turning now to FIG. 4, FIG. 4 shows a diagram of a computing device in accordance with one or more embodiments of the invention. The computer (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth® interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) (402) may be one or more cores or micro-cores of a processor. The computer (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computer (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many diverse types of computing devices exist, and the aforementioned input and output device(s) may take other forms.

One or more embodiments of the invention may be implemented using instructions executed by one or more processors of the edge environment engine. Further, such instructions may correspond to computer readable instructions that are stored on one or more non-transitory computer readable mediums.

One or more embodiments of the invention may improve upon the previous method of prioritizing network packets. Specifically, embodiments of the invention relate to a system and method of generating a prioritization policy to deploy on each edge device of an edge environment, so that edge devices may appropriately apply a prioritization rank to network packets being transmitted from an application on the edge device. The prioritization policy is generated based on environment telemetry data, environment topology information, and a currently-implemented DiffServ policy, which allows each edge device to be aware of the other devices, applications, and classifications existing in the edge environment. In this manner, there is a context-aware method for determining the priority of network packets in an edge environment and implementing the prioritization policy at a device level.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for prioritizing network packets in an edge environment, the method comprising:
monitoring, by an edge environment engine, the edge environment to obtain environment telemetry data from edge devices in the edge environment;
analyzing, by an analyzing agent of the edge environment engine, the environment telemetry data, to obtain environment topology information;
generating, using a prioritized rank model and using the environment topology information, a prioritization policy that includes a mapping between an application and a prioritization rank; and
sending, by the edge environment engine, the prioritization policy to each of the edge devices in the edge environment, wherein the edge devices apply the prioritization policy to prioritize the network packets when transmitting the network packets to other devices.

2. The method of claim 1, wherein the environment telemetry data comprises health information from each of the edge devices and application category information of the edge devices.

3. The method of claim 1, wherein the prioritization rank model is trained on the environment telemetry data and the environment topology information stored in an engine storage of the edge environment engine.

4. The method of claim 1, wherein the prioritization rank model is used to generate the prioritization policy using multiple linear regression and based on the environment telemetry data, the environment topology information, and a differentiated services (DiffServ) policy stored in an engine storage of the edge environment engine, wherein the prioritization policy comprises a ranking of applications in the edge environment based on classifications specified in the DiffServ policy, and device health information specified in the environment topology information.

5. The method of claim 4, wherein the DiffServ policy comprises an application-level classification for network packets in the edge environment.

6. The method of claim 1, wherein the prioritization rank provided by the prioritization policy is applied to an Internet Protocol (IP) header of each network packet from the application obtained by an edge device of the edge devices, wherein the applying of the prioritization rank results in the prioritization rank being included in the IP header of each network packet, wherein each edge device prioritizes transmission of each network packet using the prioritization rank.

7. The method of claim 6, wherein the edge device of the edge devices operates as a router that transmits each network packet from the application to another device.

8. The method of claim 7, wherein the router comprises the edge environment engine.

9. A non-transitory computer readable medium comprising computer readable program code, which when executed by a computer processor enables the computer processor to perform a method for prioritizing network packets in an edge environment, the method comprising:
monitoring, by an edge environment engine, the edge environment to obtain environment telemetry data from edge devices in the edge environment;
analyzing, by an analyzing agent of the edge environment engine, the environment telemetry data, to obtain environment topology information;
generating, using a prioritized rank model and using the environment topology information, a prioritization policy that includes a mapping between an application and a prioritization rank; and
sending, by the edge environment engine, the prioritization policy to each of the edge devices in the edge environment, wherein the edge devices apply the prioritization policy to prioritize the network packets when transmitting the network packets to other devices.

10. The non-transitory computer readable medium of claim 9, wherein the environment telemetry data comprises health information from each of the edge devices and application category information of the edge devices.

11. The non-transitory computer readable medium of claim 9, wherein the prioritization rank model is trained on the environment telemetry data and the environment topology information stored in an engine storage of the edge environment engine, wherein the prioritization policy comprises a ranking of applications in the edge environment based on classifications specified in a differentiated services (DiffServ) policy, and device health information specified in the environment topology information.

12. The non-transitory computer readable medium of claim 9, wherein the prioritization rank model is used to generate the prioritization policy using multiple linear regression and based on the environment telemetry data, the environment topology information, and a differentiated services (DiffServ) policy stored in an engine storage of the edge environment engine.

13. The non-transitory computer readable medium of claim 12, wherein the DiffServ policy comprises an application-level classification for network packets in the edge environment.

14. The non-transitory computer readable medium of claim 9, wherein the prioritization rank provided by the prioritization policy is applied to an Internet Protocol (IP) header of each network packet from the application obtained by an edge device of the edge devices, wherein the applying of the prioritization rank results in the prioritization rank being included in the IP header of each network packet, wherein each edge device prioritizes transmission of each network packet using the prioritization rank.

15. The non-transitory computer readable medium of claim 14, wherein the edge device of the edge devices functions as a router that transmits each network packet from the application to another device.

16. The non-transitory computer readable medium of claim 15, wherein the router comprises the edge environment engine.

17. A system, comprising:
an edge environment, comprising:
a plurality of edge devices; and
an edge environment engine, comprising circuitry, programmed to:
monitor the edge environment to obtain environment telemetry data from the plurality of edge devices;
analyze, by an analyzing agent of the edge environment engine, the environment telemetry data, to obtain environment topology information;
generate, using a prioritized rank model, a prioritization policy that includes a mapping between an application and a prioritization rank; and
send the prioritization policy to each of the plurality of edge devices;
wherein an edge device in the plurality of edge devices is programmed to:
obtain a network packet from an application to be transmitted to another device;
analyze an Internet Protocol (IP) header of the network packet to identify the application associated with the network packet;
apply, based on the prioritization policy, the prioritization rank to the IP header of the network packet; and
transmit, according to the prioritization rank, the network packet from the edge device to another device.

18. The system of claim 17, wherein the environment telemetry data comprises health information from each of the edge devices and application category information of the plurality of edge devices, and wherein the prioritization rank model is trained on the environment telemetry data and the environment topology information stored in an engine storage of the edge environment engine.

19. The system of claim 17, wherein the prioritization rank model is used to generate the prioritization policy using multiple linear regression and based on the environment telemetry data, the environment topology information, and a Differentiated Services (DiffServ) policy stored in an engine storage of the edge environment engine, wherein the prioritization policy comprises a ranking of applications in the edge environment based on classifications specified in the DiffServ policy, and device health information specified in the environment topology information, and wherein the DiffServ policy comprises an application-level classification for network packets.

20. The system of claim 17, wherein the prioritization rank provided by the prioritization policy is applied to an Internet Protocol (IP) header of each network packet from the application obtained by an edge device of the plurality of edge devices, wherein the applying of the prioritization rank results in the prioritization rank being included in the IP header of each network packet, wherein each edge device prioritizes transmission of each network packet using the prioritization rank, wherein the edge device of the plurality of edge devices functions as a router that transmits each network packet from the application to another device, and wherein the router comprises the edge environment engine.
